(19) United States
(12) Patent Application Publication
(10) Pub. No.: US 2004/0231126 A1
(43) Pub. Date: Nov. 25, 2004

(54) Coax cable tool

(76) Inventors: Ray Louwagie, Cottonwood, MN (US); Greg Hanks, Rushmore, MN (US)

Correspondence Address: Angenehm Law Firm, Ltd., P.O. Box 48755, Coon Rapids, MN, 55448-0755, US

(21) Appl. No.: 10/656,964

(22) Filed: Sep. 8, 2003

Related U.S. Application Data
(60) Provisional application No. 60/468,834, filed on May 8, 2003.

(51) Int. Cl. B23P 19/00

(52) U.S. Cl. 29/426.1

(57) ABSTRACT

A tool including a body having an inner surface and an outer surface; a central bore defined by the inner surface of the body, the central bore having a first diameter adjacent a first end of the central bore, the central bore having a second diameter adjacent a second end of the central bore, and the first diameter being larger than the second diameter; a channel defined by the body, the channel joining the inner surface to the outer surface; a first bit end of the body; and a second bit end of the body and method of use including the steps of selecting a bit end of a coax cable tool sized and configured to engage a fitting on a coax cable and to snugly and uniformly receive the coax cable; connecting the coax cable to the coax cable tool; longitudinally trapping the fitting on the coax cable between a receptacle and an engagement wall of the coax cable tool; and rotating the coax cable tool.

### FIELD OF THE INVENTION

The present invention relates to the field of hand tools and more particularly to hand tools for tightening and loosening coax cables, which claims priority from U.S. Provisional Patent Application No. 60/468,834, filed May 8, 2003 and entitled COAX CABLE TOOL.

### BACKGROUND OF THE INVENTION

Transmission of data, including audio and visual can be performed in a variety of manners, including air waves, telephone lines, and coax cables. Speed is important especially when the visual is in the form of a video. Air waves are not always available. Telephone lines tend to be too slow of a transmission rate for video. The coax cable has been developed and has found its way to common use in those situations where air waves and telephone lines are not a suitable alternative.

The coax cable has an insulated wire with a fitting mounted to the insulative wrapping and the wire extending therethrough. When secured, the wire extends into a receptacle and the fitting secures about the receptacle. Coax cables are used between television sets and video tape records or players, both to and from cable television boxes, intra-office networking of computers and a variety of other locations. Tightening of the fitting can influence the quality of the connection, thus tools for tightening and loosening the fittings is important.

Three common types of coax cables are available on the market; the RG6, the RG59 and quad shield coax cable. The RG6 and RG59 have a uniform thickness insulative coating that is smaller in cross section than the fitting. The quad shield coax cable has an insulator that differs from the RG6 and RG59 in that it is fluted adjacent the fitting. For instance, the cross section of the quad shield coax cable is similar in diameter to the cross sections of the RG6 and RG59, but the quad shield has a cross sectional diameter adjacent the fitting, which is larger in size to that of the remainder of the cable.

The fitting when tightened is commonly positioned in a location difficult to reach with plyers or wrenches, making a tool specialized for coax cables a desirable implement. One such tool was invented by Zamanzadeh, U.S. Pat. No. 5,992,010, which involves a hinged member that wraps about the coax cable. Such hinge is easily subject to breaking and is not conducive to easy removal once the cable has been tightened or loosened. Such design appears to allow the fitting to work its way into the interior cavity, since the interior is not form fitting about the cable, and it appears to not have walls that limit longitudinal movement, allowing the fitting to disengage from the tool.

What is needed is a coax cable tool for tightening and loosening the fittings on standard coax cables including RG6, RG59 and quad shield coax cables. The interior of such tool should form fit about the quad shield coax cable. The tool should lack a hinge or other moving parts that can easily break. The tool should be designed such that the maximum number of sides of the fitting should be gripped by the tool during operation.

### SUMMARY OF THE INVENTION

The tool includes a body, having an inner surface and an outer surface. A central bore is defined by the inner surface of the body. The central bore has a first diameter adjacent a first end of the central bore and a second diameter adjacent a second end of the central bore. The first diameter is smaller than the second diameter. A channel may be defined by the body. The channel joins the inner surface to the outer surface. The body further has a first bit end of the body and a second bit end of the body.

Advantageously, the present invention provides a coax cable tool suitable for use with RG6, RG59 and quad shield coax cables.

Also advantageously, the tool is structured to limit the longitudinal movement of the fitting inside the bit end, precluding longitudinal separation of the tool from the coax cable, such separation, when desired, being lateral only.

As yet a further advantage, the channel and the bore are sized to receive the RG6, RG59 and quad shield coax cables.

As still yet another advantage, the tool maximizes the number of engagement surfaces, while avoiding the use of moving parts and hinges.

### DESCRIPTION OF THE DRAWINGS

FIG. 1 is a perspective view of the present invention, showing the first and second ends;

FIG. 2 is a cross section view of FIG. 1 taken along the lines 2-2 with a quad shield coax cable joined to the tool oriented toward a receptacle;

FIG. 3 is an end view of the first end of the present invention with a quad shield coax cable joined to the tool;

FIG. 4 is the view similar to FIG. 1 with an RG6 or RG59 coax cable joined to the tool;

FIG. 5 is partial cross sectional view of FIG. 4 taken along the lines 5-5 with an RG6 or RG59 coax cable joined to the tool; and

FIG. 6 is an end view of the second end of the present invention with an RG6 or RG59 coax cable joined to the tool;

### DETAILED DESCRIPTION

The present invention is a tool 10, including a body 14 with a bore 16, channel 18, first end 30 and second end 50. The tool is specifically designed for use in tightening and loosening coax cable fittings 22 to a receptacle 94. While the tool 10 may be used for tightening and loosening other fittings, it has a bore 16 and channel 18 specifically suited for fitting about a fitting 22 on a coax cable 24. Each component will be discussed in serial fashion.

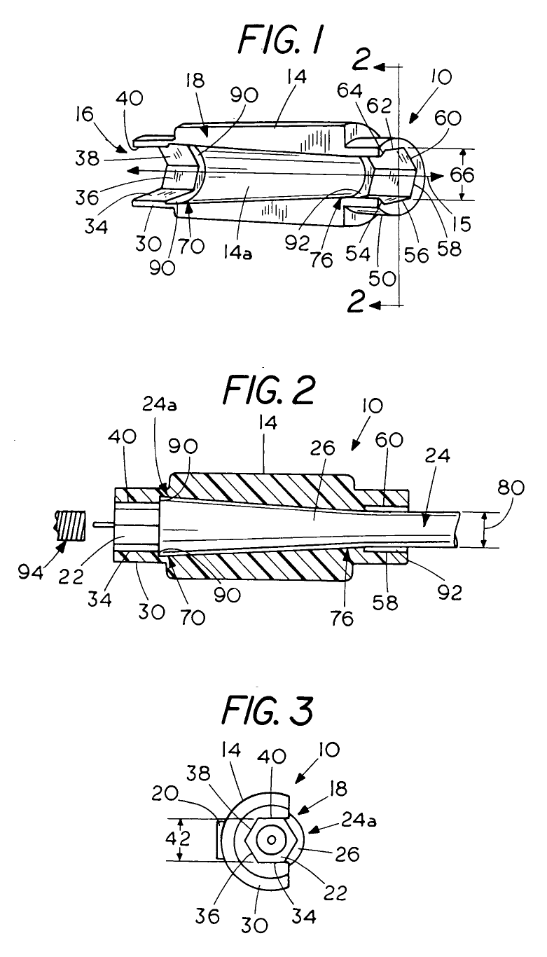

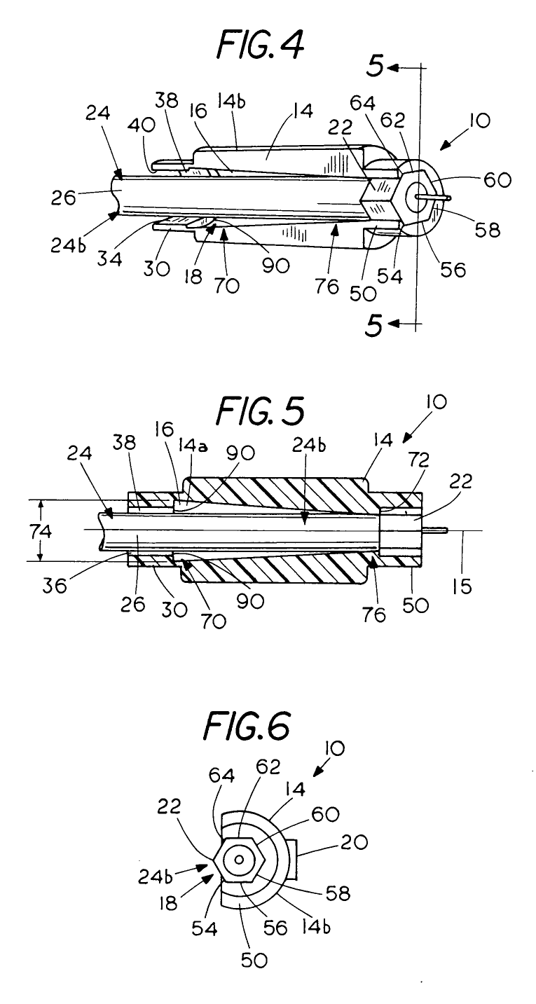

The body 14 may having an inner surface 14a and an outer surface 14b. The body 14 may be homogenous, integral or pieced. Preferably, it is formed of a hardened plastic, but may be made of other materials suitable for gripping a fitting 22 and applying pressure such as metal, wood, ceramic or other materials having sufficient strength and durability. The body 14 may include an insulation engagement wall 90 oriented perpendicular to a central axis 15 of the body 14. The cable 24 preferably is limited in longitudinal distance that it may move before engaging the insulation engagement wall 90 in one direction and the inner surface 14a in the opposite direction, preventing a fitting 22 from disengaging from the first bit end 30. The body 14 may also include a fitting engagement wall 92 oriented perpendicular to the central axis 15 of the body 14. The fitting engagement wall 15 preferably is positioned to engage the fitting 22 of the coax cable 24 when the second bit end 50 engages the fitting 22. Such engagement walls 90,92 are perhaps best viewed in FIG. 1.

A mechanism for gripping 20 may be disposed about the outer surface 14b of the body 14. The grip 20 as shown in the various figures is a ridge about which a user may frictionally engage their hand. Other mechanisms for gripping 20 may be used, including roughened surfaces, surfaces with a high friction co-efficient such as tacky materials, porous designs or other chemically or mechanically arranged surfaces that allow for easy grasping.

The central bore 16 may be defined by the inner surface 14a of the body 14. The bore 16 is preferably disposed co-axially through the body 14. The bore 14 is intended to be sized to receive RG6, RG59 and quad shield coax cable 24 therethrough. While shown in a round cross-sectional configuration, the bore 16 may be square, triangular, rectangular, irregular or any other desired shape suitable for fitting about the coax cable 24, but desirably limits longitudinal movement as described above. The central bore 16 has a first diameter 74 adjacent a first end 70 of the central bore 16 and a second diameter 80 adjacent a second end 76 of the central bore 16. The first diameter 74 may be larger than the second diameter 80.

The channel 18 may be defined by the body 14 and positioned to join the inner surface 14a to the outer surface 14b. The channel 18 is sized and configured to receive the coax cable 24 therethrough. Accordingly, the channel 18 provides a pathway allowing the coax cable 24 to enter and be received within the bore 16. The channel 18 preferably is v-shaped along a plane parallel to the central axis 15 of the body 14, e.g. along the length of the tool 10 as opposed to directing into the tool 10 or some other angle.

The first bit end 30 of the body 14 has first, second, third, and fourth engaging surfaces, 34, 36, 38 and 40 respectively. Engaging surfaces 34, 36, 38, 40 are preferably sized and disposed to firmly and accurately grasp the fitting 22 on the standard coax cable 24, such as a quad shield coax cable 24a. The engaging surfaces 34, 36, 38, 40 of the first bit end 30 may be fixed, e.g. non-moveable, in relation to each other. The first bit end 30 may laterally approach the fitting 22, e.g. not longitudinally to place the fitting 22 into the first bit end 30. The first bit end 30 may receive fitting 22 of a same or different size than fittings received by the second bit end 50. The first bit end 30 has a diameter 42, which is smaller than the diameter 74 of the first end 70 of the central bore 16.

The second bit end 50 of the body 14 may have first, second, third, fourth, fifth and sixth engaging surfaces, e.g, 54 56, 58, 60, 62 and 64 respectively. Such engaging surfaces 54 56, 58, 60, 62 and 64 may be sized and disposed to grasp a fitting 22 on a standard coax cable 24, such as an RG6 or RG59 cable 24b. The engaging surfaces of the second bit end 50 preferably are fixed, e.g., non-moveable, relative to each other. The first and sixth engaging surfaces 54, 64 may be sized differently than the remaining engaging surfaces 56, 58, 60, and 62 such that they define the channel 18 therebetween. The channel 18 desirably is of sufficient width to pass an insulative coating 26 of a coax cable 24 therethrough. The second bit end 50 preferably does not allow approaching the fitting 22 laterally, e.g. from the side, but does provide for approaching longitudinally, e.g., coaxial with the fitting 22. The second bit end 50 has a diameter 66, which may be larger than the diameter 80 of the second end 76 of the central bore 16.

In operation, a user may tighten or loosen a coax cable fitting 22. A bit end 30 or 50 sized and configured to engage a fitting 22 on a coax cable 24 is selected for application to the specific fitting 22. The bit end 30 or 50 is oriented toward the fitting 22. The coax cable 24 is passed through the channel 18 and into the bore 16 defined in the body 14 of the coax cable tool 10. The bit end 30 or 50 is engaged about the fitting 22. Such engagement may be laterally or co-axially as described above. The tool 10 is rotated about the coax cable 24 to tighten or loosen the fitting 22.

Although the present invention has been described with reference to preferred embodiments, workers skilled in the art will recognize changes may be made in form and detail without departing from the spirit and scope of the invention.

1. A tool comprising:
a body having an inner surface and an outer surface;
means for gripping disposed about an outer surface of the body;
a central bore defined by the inner surface of the body, the central bore disposed co-axially through said body, the central bore being shaped to snugly receive a quad shield coax cable longitudinally within the tool;
a channel defined by the body, the channel joining the inner surface to the outer surface, the channel being v-shape parallel to a central axis of the body;
a first bit end of the body having first, second, third, and fourth engaging surfaces, such engaging surfaces of the first bit end being sized and disposed to grasp a fitting on a coax cable and such engaging surfaces of the first bit end being fixed in relation to each other; and
a second bit end of the body having first, second, third, fourth, fifth and sixth engaging surfaces, such engaging surfaces of the second bit end being sized and disposed to grasp a fitting on a coax cable, such engaging surfaces of the second bit end being fixed relative to each other and the first and sixth engaging surfaces having the channel extend therebetween.

2. A tool comprising:
a body having an inner surface and an outer surface;
a central bore defined by the inner surface of the body, the central bore having a first diameter adjacent a first end of the central bore, the central bore having a second diameter adjacent a second end of the central bore, and the first diameter being larger than the second diameter;
a channel defined by the body, the channel joining the inner surface to the outer surface;
a first bit end of the body; and
a second bit end of the body.

3. The device of claim 2 wherein the first bit end has a diameter, the diameter of the first bit end being smaller than the diameter of the first end of the central bore.

4. The device of claim 2 wherein the second bit end has a diameter, the diameter of the second bit end being larger than the diameter of the second end of the central bore.

5. The device of claim 2, wherein the channel is v-shaped along a plane parallel to a central axis of the body.

6. The device of claim 2 wherein the body includes an insulation engagement wall oriented perpendicular to a central axis of the body, the cable being limited in longitudinal distance that the cable may move by engagement with the insulation engagement wall in one direction and by engagement with the inner surface in the opposite direction, preventing a fitting from disengaging from the first bit end.

7. The device of claim 2 wherein the body includes a fitting engagement wall oriented perpendicular to a central axis of the body, the fitting engagement wall positioned to engage a fitting of a coax cable when the second bit end engages a fitting.

8. The device of claim 2 wherein the first bit end of the body includes first, second, third, and fourth engaging surfaces.

9. The device of claim 8 wherein engaging surfaces of the first bit end are sized and disposed to grasp a fitting on a quad shield coax cable.

10. The device of claim 8 wherein the engaging surfaces of the first bit end are fixed in relation to each other.

11. The device of claim 2 wherein the second bit end of the body has first, second, third, fourth, fifth and sixth engaging surfaces.

12. The device of claim 11, wherein the engaging surface of the second bit end are sized and disposed to grasp a fitting on an RG6 and on an RG59 coax cable.

13. The device of claim 11 wherein the engaging surfaces of the second bit end are fixed relative to each other.

14. The device of claim 11 wherein the first and sixth engaging surfaces define the channel extending therebetween.

15. The device of claim 14 wherein the channel is of sufficient width to pass an insulative coating of a coax cable therethrough.

16. The device of claim 2 further comprising a coax cable positioned in the central bore.

17. A method of tightening or loosening a coax cable fitting comprising the steps of:
selecting a bit end of a coax cable tool sized and configured to engage a fitting on a coax cable and to snugly and uniformly receive the coax cable;
connecting the coax cable to the coax cable tool;
longitudinally trapping the fitting on the coax cable between a receptacle and an engagement wall of the coax cable tool; and
rotating the coax cable tool.

18. The method of claim 17 wherein the step of longitudinally trapping further comprises the step of longitudinally trapping the fitting on the coax cable between a receptacle and a fitting engagement wall of the coax cable tool.

19. The method of claim 17 wherein the step of longitudinally trapping further comprises the step of longitudinally trapping the fitting on the coax cable between a receptacle and a insulation engagement wall of the coax cable tool.
